(19) United States
(12) Patent Application Publication
(10) Pub. No.: US 2025/0161992 A1
(43) Pub. Date: May 22, 2025

(54) BEAN SORTING METHOD AND ELECTRONIC DEVICE FOR SUPPORTING SAME

(71) Applicant: MINDFORGE CO., LTD., Seoul (KR)

(72) Inventors: Taejin HWANG, Seoul (KR); Kyuyeol CHAE, Seoul (KR)

(21) Appl. No.: 19/033,008

(22) Filed: Jan. 21, 2025

Related U.S. Application Data
(63) Continuation of application No. PCT/KR2022/013521, filed on Sep. 8, 2022.

(30) Foreign Application Priority Data
Jul. 22, 2022 (KR) 10-2022-0091207
Sep. 7, 2022 (KR) 10-2022-0113611

(51) Int. Cl. B07C 5/342

(52) U.S. Cl. CPC B07C 5/3422; B07C 2501/0081

(57) ABSTRACT

An electronic device according to one embodiment comprises a camera module and at least one processor, wherein the at least one processor can be configured to: acquire a plurality of images of beans through the camera module; calculate, on the basis of the plurality of images, probabilities that the beans belong to each of a plurality of categories; and sort the beans on the basis of the probabilities. The present disclosure relates to a technology developed through an “AI-based coffee bean automatic sorting system” of the Seoul Special City Seoul Business Agency 2021 Artificial Intelligence (AI) Technology Business Support Project (CY210016).

### CROSS-REFERENCE TO RELATED APPLICATION(S)

This application is a continuation application, claiming priority under 35 U.S.C. § 365 (c), of an International application No. PCT/KR2022/013521, filed on Sep. 8, 2022, which is based on and claims the benefit of a Korean patent application number 10-2022-0091207, filed on Jul. 22, 2022, Korean Patent Application No. 10-2022-0113611, filed on Sep. 7, 2022 in the Korean Intellectual Property Office, the entire disclosure of which is incorporated herein by reference.

### TECHNICAL FIELD

The disclosure relates to a method for classifying beans and an electronic device supporting the same.

### BACKGROUND ART

Beans (e.g., coffee beans) may be classified into different types. For example, beans can be classified into 12 different types, depending on the shape, appearance, and/or color of the bean, such as normal, black, over-fermented, moldy, worm-eaten, dry, chlorotic, deformed, shell, broken, cracked, and foreign substance.

An electronic device obtains an image of one surface of a bean through a camera and classifies the type of the bean based on the obtained image.

The present disclosure relates to a technology developed through an “AI-based coffee bean automatic sorting system” of the Seoul Special City Seoul Business Agency 2021 Artificial Intelligence (AI) Technology Business Support Project (CY210016).

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Problem

If the type of a bean is classified based on images of one surface of the bean, the bean may not be accurately classified. For example, one surface of the bean may have the form, shape, and/or color corresponding to a normal bean, and the other surface of the bean may have the form, shape, and/or color corresponding to a worm-eaten head. In this case, when determining the type of the bean based on an image for one surface of the bean, the type of the bean may be classified as a normal bean or a worm-eaten bean depending on the surface of the bean captured through the camera. Accordingly, it is necessary to classify the bean based on images captured for different surfaces of the bean.

The disclosure relates to a method for classifying a bean, which may accurately classify the bean based on a plurality of images of the bean, and an electronic device supporting the same.

Objects of the disclosure are not limited to the foregoing, and other unmentioned objects would be apparent to one of ordinary skill in the art from the following description.

Additional aspects will be set forth in part in the description which follows and, in part, will be apparent from the description, or may be learned by practice of the presented embodiments

### Technical Solution

In accordance with an aspect of the disclosure, an electronic device is provided. The electronic device comprises a transparent plate, a plurality of cameras including a first camera and a second camera, the first camera being disposed to face one surface of the transparent plate, the second camera being disposed to face a surface, opposite to the one surface, of transparent plate, and at least one processor. The at least one processor may be configured to while a bean is moved on the transparent plate, simultaneously obtain a first image for a first surface of the bean through the first camera and a second image for a second surface of the bean through the second camera, the second surface being different from the first surface; using an artificial intelligence (AI) model, calculate, based on the first image, first probabilities that the bean belongs to each of a plurality of classification items and calculate, based on the second image, second probabilities that the bean belongs to each of the plurality of classification items; identify, among the plurality of classification items, a first classification item corresponding to a third probability highest among the first probabilities and identify, among the plurality of classification items, a second classification item corresponding to a fourth probability highest among the second probabilities; based on the first classification item being a same as the second classification item, determine the first classification item as a type of the bean; based on the first classification item being not a same as the second classification item, identify whether the first classification item or the second classification item corresponds to a designated classification item, wherein the designated classification item is designated by a user input; based on the first classification item or the second classification item corresponding to the designated classification item, identify whether a probability of a classification item, corresponding to the designated classification item between the first classification item and the second classification item, between the third probability and the fourth probability is greater than or equal to a first threshold; and based on the probability of the classification item corresponding to the designated classification item being greater than or equal to the first threshold, determine the classification item as the type of the bean.

In accordance with another aspect of the disclosure, a method is provided. The method comprises while a bean is moved on a transparent plate of the electronic device, simultaneously obtain a first image for a first surface of the bean through a first camera and a second image for a second surface of the bean through a second camera, the second surface being different from the first surface, wherein the first camera and the second camera are included in a plurality of cameras, the first camera being disposed to face one surface of the transparent plate, the second camera being disposed to face a surface, opposite to the one surface, of transparent plate; using an artificial intelligence (AI) model, calculating, based on the first image, first probabilities that the bean belongs to each of a plurality of classification items and calculating, based on the second image, second probabilities that the bean belongs to each of the plurality of classification items; identifying, among the plurality of classification items, a first classification item corresponding to a third probability highest among the first probabilities and identifying, among the plurality of classification items, a second classification item corresponding to a fourth probability highest among the second probabilities; based on the first classification item being a same as the second classification item, determining the first classification item as a type of the bean; based on the first classification item being not a same as the second classification item, identifying whether the first classification item or the second classification item corresponds to a designated classification item, wherein the designated classification item is designated by a user input; based on the first classification item or the second classification item corresponding to the designated classification item, identifying whether a probability of a classification item, corresponding to the designated classification item between the first classification item and the second classification item, between the third probability and the fourth probability is greater than or equal to a first threshold; and based on the probability of the classification item corresponding to the designated classification item being greater than or equal to the first threshold, determining the classification item as the type of the bean.

In accordance with another aspect of the disclosure, In accordance with an aspect of the disclosure, an electronic device is provided. The electronic device comprises a transparent plate, a plurality of cameras including a first camera and a second camera, the first camera being disposed to face one surface of the transparent plate, the second camera being disposed to face a surface, opposite to the one surface, of transparent plate, and at least one processor. The at least one processor may be configured to while a bean, classified as a first type by a user, is moved on the transparent plate, simultaneously obtain a first image for an upper surface of the bean through the first camera and a second image for a lower surface of the bean through the second camera; using an artificial intelligence (AI) model, calculate, based on the first image, first probabilities that the bean belongs to each of a plurality of classification items and calculate, based on the second image, second probabilities that the bean belongs to each of the plurality of classification items; identify, among the plurality of classification items, a first classification item corresponding to a third probability highest among the first probabilities and identify, among the plurality of classification items, a second classification item corresponding to a fourth probability highest among the second probabilities; and based on a probability of a classification item corresponding to the first type between the first classification item and the second classification item between the third probability and the fourth probability, set a threshold for classifying the bean.

### Advantageous Effects

A method for classifying a bean and an electronic device supporting the same according to the disclosure may accurately classify a bean based on a plurality of images for different surfaces of the bean.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a plan view illustrating an electronic device according to an embodiment;

FIG. 2 is a side view illustrating an electronic device according to an embodiment;

FIG. 3 is a view illustrating an electronic device including a plurality of camera modules according to an embodiment;

FIG. 4 is a view illustrating an electronic device including a camera module and a mirror according to an embodiment;

FIG. 5 is a view illustrating an electronic device for obtaining a plurality of images according to an embodiment;

FIG. 6 is a view illustrating an electronic device including a patch according to an embodiment;

FIG. 7 is a block diagram illustrating an electronic device according to an embodiment;

FIG. 8 is a flowchart illustrating a method for classifying beans according to an embodiment;

FIG. 9 is a flowchart illustrating a method for classifying beans according to an embodiment;

FIG. 10 is a flowchart illustrating a method for classifying beans according to an embodiment;

FIG. 11 is a flowchart illustrating a method for classifying beans by a first method according to an embodiment;

FIG. 12 is a view illustrating an example of a method for classifying beans by a first method according to an embodiment;

FIG. 13 is a view illustrating an example of a method for classifying beans by a second method according to an embodiment;

FIG. 14 is a view illustrating an example of a method for classifying beans by a third method according to an embodiment; and

FIG. 15 is a view illustrating an example of a method for selecting a method for classifying beans based on a user input according to an embodiment.

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As embodiments disclosed herein are provided to provide a clear description of the spirit of the disclosure to one of ordinary skill in the art, the disclosure is not limited to the disclosed embodiments. According to various embodiments, the scope of the disclosure should be interpreted as including modifications or changes thereto without departing from the spirit of the disclosure.

Although terms commonly and widely used are adopted herein considering the functions in the disclosure, other terms may also be used depending on the intent of one of ordinary skill in the art, custom, or advent of new technology. For specific terms, their definitions may be provided. Accordingly, the terms used herein should be determined based on their meanings and the overall disclosure, rather than by the terms themselves.

The accompanying drawings are provided for a better understanding of the disclosure. Some views may be exaggerated in aid of understanding as necessary. The disclosure is not limited to the drawings.

When determined to make the gist of the disclosure unclear, a detailed description of known configurations or functions may be omitted as necessary.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Operations of a machine described in embodiments of the disclosure may be implemented as software (e.g., the program) including one or more instructions that are stored in a recording medium (or storage medium) that is readable by the machine. For example, a control circuit (e.g., a processor) of the machine may invoke at least one of the one or more instructions stored in the recording medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

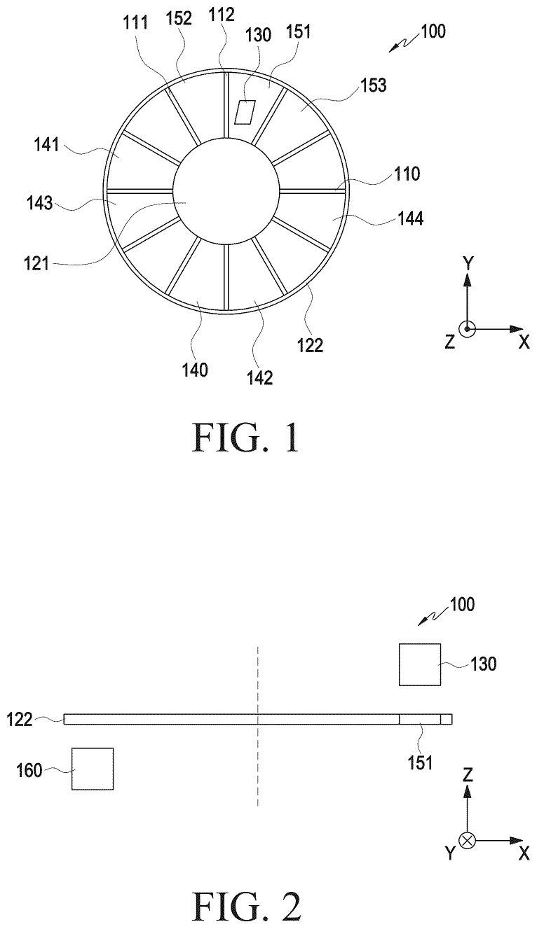

FIG. 1 is a plan view illustrating an electronic device 100 according to an embodiment.

FIG. 2 is a side view illustrating an electronic device 100 according to an embodiment.

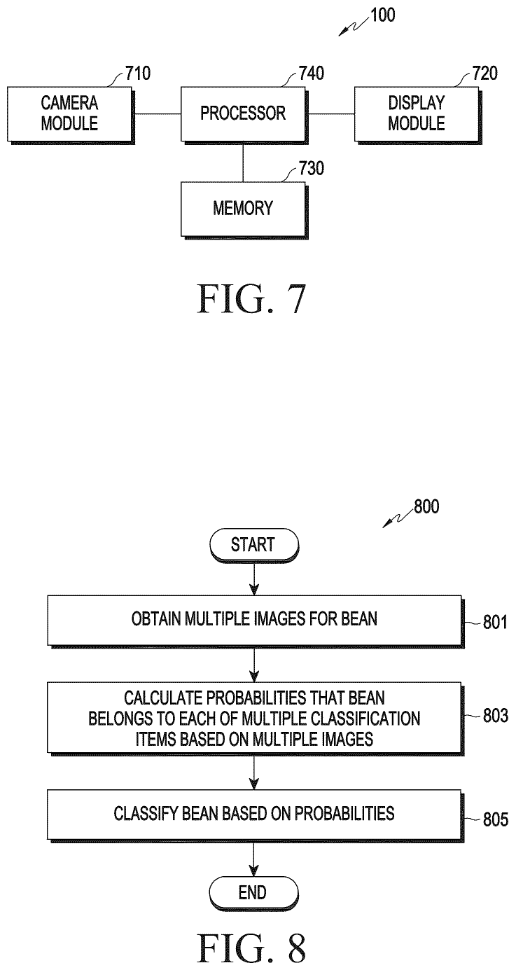

Referring to FIGS. 1 and 2, in an embodiment, the electronic device 100 may include a rotating member 110, 121, and 122, a camera module 130, a rotating plate 140, a display module (not shown) (e.g., the display module 720 of FIG. 7), memory (e.g., the memory 730 of FIG. 7), and/or a processor (not shown) (e.g., the processor 740 of FIG. 7).

In an embodiment, the rotating member may include a first portion 121 which form a central portion of the rotating member, a plurality of second portions 110 (also referred to as “a plurality of wings”), and a third portion 122 forming an edge of the rotating member.

In an embodiment, a plurality of spaces (e.g., 141, 142, 143, 151, 152, and 153) (hereinafter referred to as “a plurality of spaces”) may be formed by the first portion 121, the plurality of second portions 110, the third portion 122, and the rotating plate 140. For example, as illustrated in FIG. 1, 12 spaces may be formed by the first portion 121, the plurality of second portions 110, the third portion 122, and the rotating plate 140. However, the disclosure is not limited thereto. For example, the number of the plurality of spaces may be the same as the number of the plurality of second portions. For example, the number of the plurality of spaces may be less than 12 or may exceed 12.

In an embodiment, while the operation of classifying the bean is performed, one bean may be disposed in each of the plurality of spaces.

In an embodiment, among the plurality of spaces, the first space 141 may be a space into which the bean is inserted. In an embodiment, among the plurality of spaces, the camera module 130 may be disposed on the second space 151. For example, as illustrated in FIG. 2, the camera module 130 may be disposed at a position spaced apart from the second space 151 by a predetermined distance in the Z-axis.

In an embodiment, among the plurality of spaces, the third space (e.g., the space 142, the space 143, or the space 144) may be a space where the bean of which type (or classification item) has been determined is discharged. A portion corresponding to the third space in the rotating plate 140 may be opened by the control of the processor so that the bean is discharged from each third space. As the portion corresponding to the third space in the rotating plate 140 is opened, a hole is formed in the third space, and the classified bean may be collected into a member 160 (also referred to as a “discharge port”) disposed under the third space as illustrated in FIG. 2. Although FIG. 2 illustrates one member 160 for collecting beans, the disclosure is not limited thereto, and a plurality of members for collecting the classified beans may be included in the electronic device 100 based on the number of types of beans to be classified.

In an embodiment, the rotating member may be rotated clockwise (or counterclockwise) on the rotating plate 140 under the control of the processor 740. For example, when the driving motor (not shown) is driven under the control of the processor 740, the rotating member may be rotated clockwise by the driving motor. In an embodiment, the rotating member may be rotated at designated time intervals (e.g., periodically). For example, the rotating member may repeatedly perform an operation of rotating and an operation of stopping the rotation at each designated time. In an embodiment, the rotating member may be rotated by an angular interval corresponding to one of the plurality of spaces at each designated time. For example, the second portion 111 (e.g., one of the second portions 100) of the rotating member may be disposed at the position shown in FIG. 1 at a first time. The rotating member may be rotated so that the second portion 111 of the rotating member is disposed at the position where the second portion 112 (e.g., one of the second portions 100) of the rotating member was disposed at the first time, at the second time (e.g., the second time corresponding to the next cycle of the first time) after the first time. The rotating member may be rotated again after a designated time from the second time.

In an embodiment, the rotating plate 140 may support the rotating member.

In an embodiment, the rotating plate 140 may include areas respectively corresponding to the plurality of spaces. In an embodiment, some areas of the rotating plate 140 may be opened or closed under the control of the processor 740. For example, each of some areas of the rotating plate 140 may be opened to discharge beans disposed in each of the third spaces (e.g., the space 142, the space 143, and the space 144) among the plurality of spaces. For example, each of some areas of the rotating plate 140 may be closed so that beans disposed in each of the third spaces (e.g., the space 142, the space 143, and the space 144) are not discharged while the rotating plate 140 is rotating.

In an embodiment, each of the areas opened or closed in the rotating plate 140 may be an area corresponding to the classification item of the bean (or type of bean). For example, the area of the rotating plate 140 corresponding to the space 142 may be an area where beans classified as normal beans by the processor 740 are discharged. The area of the rotating plate 140 corresponding to the space 143 may be an area where beans classified as moldy beans by the processor 740 are discharged. The area of the rotating plate 140 corresponding to the space 144 may be an area where beans classified as shell beans by the processor 740 are discharged. For example, by the rotation of the rotating member, if the bean classified as the normal bean by the processor 740 is positioned in the area of the rotating plate 140 corresponding to the space 142, the area of the rotating plate 140 corresponding to the space 142 may be opened. By the rotation of the rotating member, when the bean classified as the moldy bean by the processor 740 is positioned in the area of the rotating plate 140 corresponding to the space 142, the area of the rotating plate 140 corresponding to the space 142 may be closed so that the bean classified as the moldy bean is not discharged through the area of the rotating plate 140 corresponding to the space 142. By the rotation of the rotating member, when the bean classified as the moldy bean by the processor 740 is positioned in the area of the rotating plate 140 corresponding to the space 143, the area of the rotating plate 140 corresponding to the space 143 may be opened so that the bean classified as the moldy bean by the processor 740 may be discharged.

In an embodiment, the camera module 130 may obtain an image for the bean when the bean is positioned at the angle of view (the angle-of-view area) of the camera module 130 by the rotation of the rotating member. For example, when the bean put into the first space 141 is positioned in the second space 151 within the angle-of-view range of the camera module 130 by the rotation of the rotating member, the camera module 130 may obtain an image for the bean by capturing the bean. However, the disclosure is not limited thereto. For example, when it is positioned in the space 152 (e.g., a space adjacent to the second space 151), the second space 151, and the space 153 (e.g., a space adjacent to the second space 151) within the angle-of-view range of the camera module 130 by rotation of the rotating member, the camera module 130 may obtain a plurality of images for the bean by capturing the bean disposed in each of the space 152, the second space 151, and the space 153.

In an embodiment, the area of the rotating plate 140 corresponding to the second space 151 (and spaces adjacent to the second space 151) corresponding to the position of the camera module 130 may be implemented as a transparent area. However, the disclosure is not limited thereto, and at least a partial area of the rotating plate 140 may be implemented as a transparent area (e.g., a transparent plate).

In an embodiment, at least a partial area of the rotating plate 140 may be implemented of a material with frictional force that causes the beans to roll by rotation of the rotating member. For example, if at least a partial area of the rotating plate 140 is implemented to roll the beans as the rotating member rotates on the rotating plate 140, an image for each of the plurality of surfaces of the bean may be obtained through the camera module 130. In an embodiment, the plurality of surfaces of the bean captured by the camera module 130 may not have portions overlapping each other, or may have an overlapping portion.

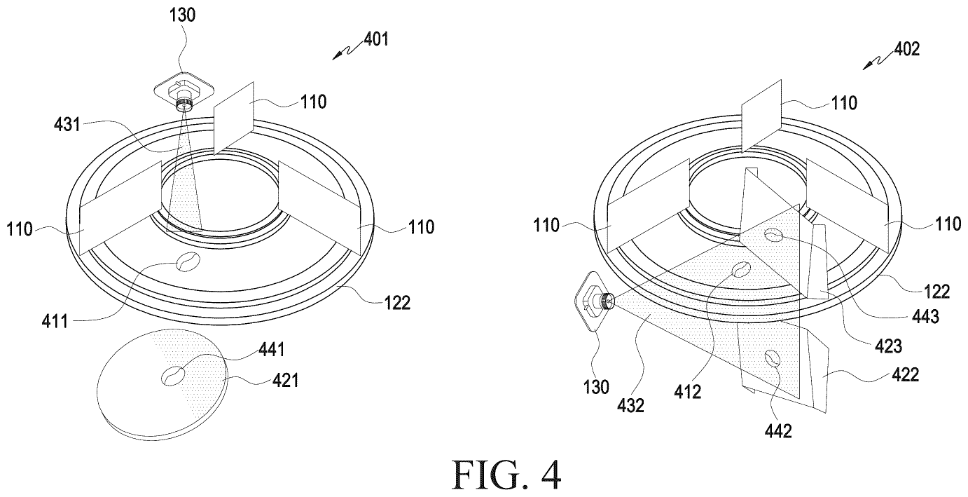

In an embodiment, the electronic device 100 may obtain a plurality of images for the bean through the camera module 130. For example, the electronic device 100 may obtain a plurality of images for each of the plurality of surfaces of the bean through the camera module 130. Although FIGS. 1 and 2 illustrate that the electronic device 100 includes one camera, the disclosure is not limited thereto. For example, the electronic device 100 may include a plurality of camera modules 130. Hereinafter, a method of obtaining a plurality of images (e.g., a plurality of images for one bean) for the bean by the electronic device 100 is described in more detail with reference to FIGS. 4 to 6.

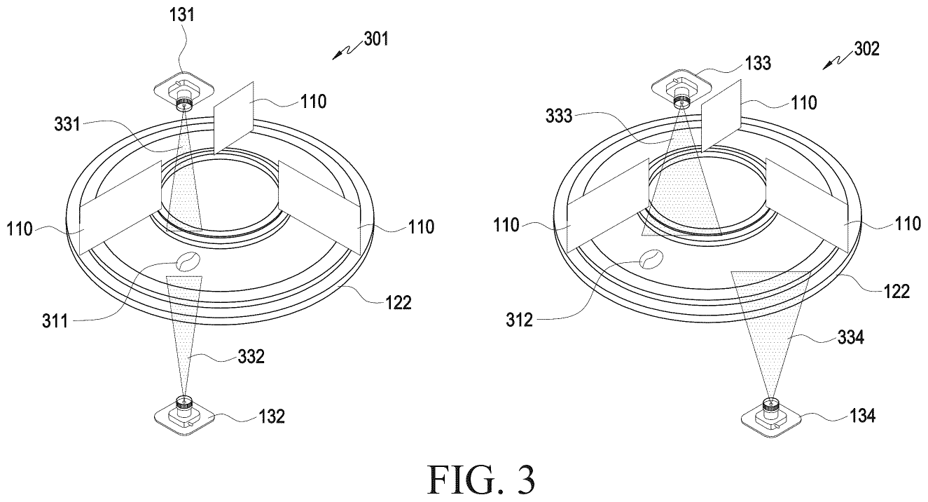

FIG. 3 is a view illustrating an electronic device 100 including a plurality of cameras according to an embodiment.

Referring to FIG. 3, in an embodiment, the electronic device 100 may include a plurality of camera modules 131 and 132.

In an embodiment, the electronic device 100 may include a first camera module for capturing one surface (e.g., the upper surface of the bean) and a second camera module for capturing the other surface (e.g., the lower surface of the bean) of the bean.

In an embodiment, when the second camera module for capturing the lower surface of the bean is disposed under the rotating plate 140, the area of the rotating plate 140 corresponding to the second camera module (e.g., an area of the rotating plate 140 including a point where a line representing the center of the angle of view of the second camera module crosses the rotating plate 140) may be implemented as a transparent plate so that the second camera module may capture the bean disposed on the rotating plate 140.

In an embodiment, as illustrated by reference numeral 301, the electronic device 100 may include a first camera module 131 and a second camera module 132 disposed on a line formed perpendicular to one surface of the rotating member. The first camera module 131 and the second camera module 132 may obtain a first image for the upper surface of the bean and a second image for the lower surface of the bean by simultaneously capturing the upper surface and the lower surface of the bean disposed in the angles of view 331 and 332, respectively. The first camera module 131 and the second camera module 132 may obtain an image for the upper surface of the bean disposed in a designated space and an image for the lower surface of the bean by being moved by the rotating member (e.g., the second portion of the rotating member) while the rotating member is rotating.

In an embodiment, as illustrated by reference numeral 302, the electronic device 100 may include a first camera module 133 and a second camera module 134 respectively disposed on different lines formed perpendicular to one surface of the rotating member. For example, the first camera module 133 and the second camera module 134 may be disposed so that angles of view (e.g., angle-of-view areas) 333 and 334 do not overlap each other. When the first bean 312 is positioned in the first area of the rotating plate 140 corresponding to the first camera module 133, the first camera module 133 may obtain an image for one surface of the first bean 312. The first bean 312 may be moved to the second area of the rotating plate 140 corresponding to the second camera module 134 by rotation of the rotating member. The first bean 312 may be rolled by the frictional force of the rotating plate 140 (or by the second portion of the rotating member) while moving from the first area of the rotating plate 140 to the second area of the rotating plate 140. When the second camera module 134 is disposed in the second area of the rotating plate 140 as the first bean 312 is rolled, the second camera module 134 may obtain an image for another surface different from the one surface of the first bean 312.

FIG. 4 is a view illustrating an electronic device 100 including a camera module and a mirror according to an embodiment.

Referring to FIG. 4, in an embodiment, the electronic device 100 may include one camera module 130 and a mirror 421.

In an embodiment, the camera module 130 may obtain an image for one surface (e.g., the upper surface of the bean) of the bean 411 disposed within the angle of view of the camera module 130, and obtain an image for the image 441 for another surface of the bean 411 by the mirror 421.

In an embodiment, when the mirror 421 forming the image 441 for the lower surface of the bean 411 is disposed under the rotating plate 140, the area of the rotating plate 140 corresponding to the mirror 421 (e.g., an area of the rotating plate 140 including the point where the line where the light reflected by the bean 411 and the mirror 421 is incident on the camera module 130 crosses the rotating plate 140) may be implemented as a transparent plate so that the camera module 130 may capture an image for the lower surface of the bean 411 formed by the mirror 421.

In an embodiment, as illustrated by reference numeral 401, the electronic device 100 may obtain a plurality of images respectively corresponding to the plurality of surfaces of the bean 411 within the angle of view 431 of the camera module 130 using one camera module 130 and the mirror 421.

In an embodiment, as illustrated by reference numeral 401, the electronic device 100 may include one camera module 130 and a plurality of mirrors 422 and 422. The camera module 130 may obtain images for the images 442 and 443 of the beans 412 respectively formed in the first mirror 422 and the second mirror 423, together with the image for the bean 412 positioned within the angle of view 432 of the camera module 130.

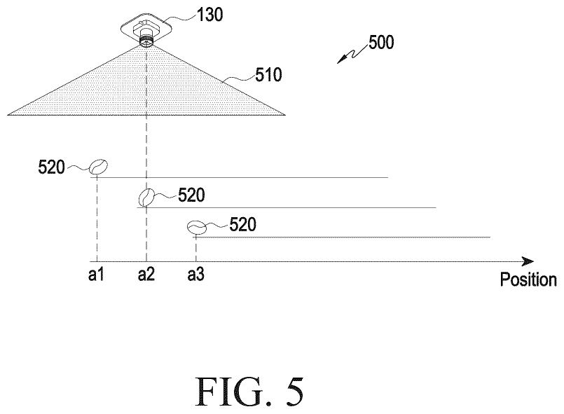

FIG. 5 is a view 500 illustrating an electronic device 100 for obtaining a plurality of images according to an embodiment.

Referring to FIG. 5, in an embodiment, the electronic device 100 may include one camera module 130. The camera module 130 may obtain a plurality of images for the bean 520 (e.g., one bean) at different times.

In an embodiment, in FIG. 5, as the bean 520 is moved by the rotating member, the position of the bean 520 (e.g., the area of the rotating plate 140 where the bean is disposed) may be changed. The camera module 130 may obtain an image for the bean 520 positioned at a1 at the first time, obtain an image for the bean 520 positioned at a2 at the second time, which is a designated time after the first time, and obtain an image for the bean 520 positioned at a3 at the third time, which is a designated time after the second time.

In an embodiment, a1, a2, and a3 representing the positions of the bean 520 may correspond to the space 152, the second space 151, and the space 153 of FIG. 1, respectively. For example, when the bean moved by the rotating member is disposed in each of the space 152, the second space 151, and the space 153 which are positioned within the angle of view 510 of the camera module 130, the camera module 130 may obtain images for a plurality of surfaces of the bean 520 by capturing the bean 520.

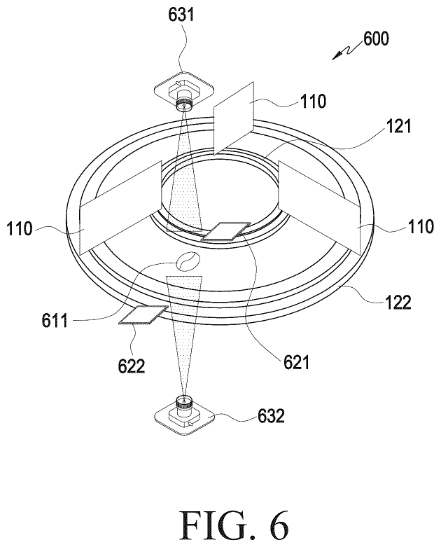

FIG. 6 is a view 600 illustrating an electronic device 100 including a patch according to an embodiment.

Referring to FIG. 6, in an embodiment, the electronic device 100 may further include at least one patch 621 and 622, in addition to the rotating member 110, 121, and 122, the plurality of camera modules 631 and 632, the rotating plate 140, the display module (not shown) (e.g., the display module 720 of FIG. 7), the memory (e.g., the memory 730 of FIG. 7), and the processor (e.g., the processor 740 of FIG. 7).

In an embodiment, at least one patch 621 and 622 may be disposed on the first portion 121 of the rotating member and/or the second portions 100 of the rotating member. In an embodiment, at least one patch 621 and 622 may be disposed to be captured by the plurality of camera modules. For example, the first patch 621 may be disposed to be captured by the first camera module 631, and the second patch 622 may be disposed to be captured by the second camera module 632.

In an embodiment, the electronic device 100 may set the settings of the camera module, including the brightness value, the exposure value, and/or the color temperature, using at least one patch 621 and 622.

In an embodiment, the electronic device 100 may perform an automatic white balance using at least one patch 621 and 622 while obtaining a plurality of images for the bean 611. For example, the electronic device 100 may obtain a first image for the first patch 621 (e.g., a white patch) through the first camera module. The electronic device 100 may obtain a second image for the second patch 622 (e.g., a patch having the same white color as the first patch 621) through the second camera module. The electronic device 100 may set a value for adjusting the white balance of the first camera module and/or the second camera module so that the image to be obtained by the first camera module and the image to be obtained by the second camera module have the same color temperature, based on the first image and the second image. In the above-described example, it is illustrated that the patches 621 and 622 are used for white balance adjustment, but the disclosure is not limited thereto. For example, a value for setting the white balance of the camera module may be set by implementing the rotating member and/or the rotating plate 140 in a white color instead of or in addition to the patches 621 and 622.

In an embodiment, the electronic device 100 may perform auto color correction using at least one patch 621 and 622. For example, the electronic device 100 may obtain a first image for the first patch 621 (e.g., a red patch with a first pixel value (e.g., a gray scale)) through the first camera module. The electronic device 100 may obtain a second image for the second patch 622 (e.g., a red patch having the same first pixel value as the first patch 621) through the second camera module. The electronic device 100 may set a value for correcting the color of the first camera module and/or the second camera module so that the image to be obtained by the first camera module and the image to be obtained by the second camera module have the same red color. In the above-described example, it is illustrated that red color is used for color correction, but the disclosure is not limited thereto. For example, in addition to the red color, at least one patch may further include patches used to correct the green color and/or blue color.

In an embodiment, the electronic device 100 may further include at least one patch 621 and 622, so that the image to be obtained by the first camera module and the image to be obtained by the second camera module have the same color temperature and/or color (brightness value and/or exposure value).

In an embodiment, the electronic device 100 may determine the degree of foreign substances that may be left on the electronic device 100 (e.g., the rotating member and/or the rotating plate 140) based on the image for at least one patch 621 and 622. The electronic device 100 may output a notification notifying the user to clean the electronic device 100 based on the degree of the foreign substance.

FIG. 7 is a block diagram illustrating an electronic device 100 according to an embodiment.

Referring to FIG. 7, in an embodiment, the electronic device 100 may include a camera module 710, a display module 720, memory 730, and/or a processor 740. However, without limitations thereto, the electronic device 100 may further include, as described through FIGS. 1 to 6, a rotating member, a rotating plate 140, mirrors 421, 422, and 423, patches 621 and 622, a member 160 for collecting classified beans, a driving motor for rotating the rotating member, and/or a component for opening/closing at least a partial area of the rotating plate 140.

In an embodiment, the camera module 710 may capture a still image and a video. In an embodiment, the camera module 710 may include one or more lenses, image sensors, image signal processors 740, or flashes.

In an embodiment, the camera module 710 (e.g., the camera module 130, 131, 132, 133, 134, 631, or 632) may obtain an image for the bean while the rotating member rotates. For example, while the rotating member rotates at designated time intervals, the bean may be moved by the rotating member (e.g., the second portion of the rotating member). The camera module 710 may obtain a plurality of images for each of a plurality of surfaces of the moving bean.

In an embodiment, the display module 720 may visually provide information to the outside (e.g., the user) of the electronic device 100. In an embodiment, the display module 720 may include a touch sensor configured to detect a touch, or a pressure sensor configured to measure the strength of a force generated by the touch.

In an embodiment, the display module 720 may display various information while performing the operation of classifying the bean. The display module 720 may display various screens to receive a user input for setting a mode for classifying the bean. The information and/or screen displayed by the display module 720 is described below in detail.

In an embodiment, the memory 730 may store various data used by at least one component (e.g., the processor 740) of the electronic device 100. The data may include, e.g., input data or output data for software (e.g., a program) and related commands. The memory 730 may include volatile memory or nonvolatile memory.

In an embodiment, the memory 730 may store information for performing the operation of classifying beans. The information stored in the memory 730 is described below in detail.

According to an embodiment, the processor 740 may execute, for example, software (e.g., a program) to control at least one other component (e.g., a hardware or software component) of the electronic device 100 coupled with the processor 740, and may perform various data processing or computation. According to an embodiment, as at least part of the data processing or computation, the processor 740 may store a command or data received from another component onto a volatile memory, process the command or the data stored in the volatile memory, and store resulting data in a non-volatile memory. According to an embodiment, the processor 740 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121.

In an embodiment, the processor 740 may control the overall operation for classifying a bean. In an embodiment, the processor 740 may include one or more processors for performing an operation for classifying a bean.

Hereinafter, operations performed to classify a bean by the processor 740 are described in detail with reference to FIGS. 8 to 15.

The electronic device may comprise a transparent plate, a plurality of cameras including a first camera and a second camera, the first camera being disposed to face one surface of the transparent plate, the second camera being disposed to face a surface, opposite to the one surface, of transparent plate, and at least one processor. The at least one processor may be configured to while a bean is moved on the transparent plate, simultaneously obtain a first image for a first surface of the bean through the first camera and a second image for a second surface of the bean through the second camera, the second surface being different from the first surface; using an artificial intelligence (AI) model, calculate, based on the first image, first probabilities that the bean belongs to each of a plurality of classification items and calculate, based on the second image, second probabilities that the bean belongs to each of the plurality of classification items; identify, among the plurality of classification items, a first classification item corresponding to a third probability highest among the first probabilities and identify, among the plurality of classification items, a second classification item corresponding to a fourth probability highest among the second probabilities; based on the first classification item being a same as the second classification item, determine the first classification item as a type of the bean; based on the first classification item being not a same as the second classification item, identify whether the first classification item or the second classification item corresponds to a designated classification item, wherein the designated classification item is designated by a user input; based on the first classification item or the second classification item corresponding to the designated classification item, identify whether a probability of a classification item, corresponding to the designated classification item between the first classification item and the second classification item, between the third probability and the fourth probability is greater than or equal to a first threshold; and based on the probability of the classification item corresponding to the designated classification item being greater than or equal to the first threshold, determine the classification item as the type of the bean.

In an embodiment, the electronic device may further comprise at least one patch. The at least one processor may be further configured to obtain an image for the at least one patch through the plurality of cameras; and based on the image for the at least one patch, set a setting related to auto white balance and/or auto color correction of the plurality of cameras.

In an embodiment, the at least one processor may be further configured to based on the first classification item and the second classification item not corresponding to the designated classification item or the probability of the classification item corresponding to the designated classification item being less than the first threshold, identify whether the first classification item or the second classification item corresponds to a normal bean among the plurality of classification items; and based on the first classification item or the second classification item corresponding to the normal bean, determine, as the type of the bean, a classification item which does not correspond to normal bean between the first classification item and the second classification item.

In an embodiment, the at least one processor may be further configured to based on the first classification item and the second classification item not corresponding to the normal bean among the plurality of classification items, identify whether a difference between the third probability and the fourth probability is greater than or equal to a second threshold; and based on the difference between the third probability and the fourth probability being greater than or equal to the second threshold, determine, as the type of the bean, a classification item, corresponding to probability higher between the third probability and the fourth probability, between the first classification item and the second classification item.

In an embodiment, the at least one processor may be further configured to based on the difference between the third probability and the fourth probability being less than the second threshold, identify weights set for the first classification item and the second classification item; and based on the third probability, the fourth probability, and the weights, determine the type of the bean.

In an embodiment, the at least one processor may be further configured to based on a user input, set the weights.

In an embodiment, the at least one processor may be further configured to based on a user input, set the first threshold corresponding to the classification item.

In an embodiment, the first surface of the bean may include an upper surface of the bean, and the second surface of the bean may include a lower surface of the bean.

In an embodiment, the first image and the second image may include still images or moving images.

In an embodiment, the electronic device may comprise a transparent plate, a plurality of cameras including a first camera and a second camera, the first camera being disposed to face one surface of the transparent plate, the second camera being disposed to face a surface, opposite to the one surface, of transparent plate, and at least one processor. The at least one processor may be configured to while a bean, classified as a first type by a user, is moved on the transparent plate, simultaneously obtain a first image for an upper surface of the bean through the first camera and a second image for a lower surface of the bean through the second camera; using an artificial intelligence (AI) model, calculate, based on the first image, first probabilities that the bean belongs to each of a plurality of classification items and calculate, based on the second image, second probabilities that the bean belongs to each of the plurality of classification items; identify, among the plurality of classification items, a first classification item corresponding to a third probability highest among the first probabilities and identify, among the plurality of classification items, a second classification item corresponding to a fourth probability highest among the second probabilities; and based on a probability of a classification item corresponding to the first type between the first classification item and the second classification item between the third probability and the fourth probability, set a threshold for classifying the bean.

In an embodiment, the at least one processor may be further configured to based on the probability of the classification item being different from a previously set threshold, set the probability of the classification item as the threshold for classifying the bean.

FIG. 8 is a flowchart 800 illustrating a method for classifying a bean according to an embodiment.

Referring to FIG. 8, in operation 801, in an embodiment, the processor 740 may obtain a plurality of images for the bean through the camera module 710.

In an embodiment, the processor 740 may obtain a plurality of images for each of a plurality of surfaces of the bean (e.g., one bean) through a plurality of camera modules. For example, the processor (740) may obtain a first image for one side of the bean and an image for the other side of the bean through the first camera modules (131, 133) for capturing one side of the bean (e.g., the upper surface of the bean) and the second camera modules (132, 134) for capturing the other side of the bean (e.g., the lower surface of the bean).

In an embodiment, the processor 740 may obtain a plurality of images for each of a plurality of surfaces of the bean (e.g., one bean) through the camera module 710 and at least one mirror. For example, the processor 740 may obtain an image for one surface of the bean (e.g., the upper surface of the bean) disposed within the angle of view of the camera module 140 and an image for the image for a surface different from the one surface of the bean by the mirror 421, as described through FIG. 4.

In an embodiment, the processor 740 may obtain a plurality of images for the bean at different times through the camera module 710. For example, as described through FIG. 5, as the bean is moved by the rotating member, the position of the bean (e.g., the area of the rotating plate 140 where the bean is disposed) may be changed. The processor 740 may obtain an image for the bean positioned in the first area of the rotating plate 140 at a first time, obtain an image for the bean positioned in the second area of the rotating plate 140 at a second time which is a designated time after the first time, and obtain an image for the bean positioned in the third area of the rotating plate 140 at a third time which is a designated time after the second time.

In the above-described examples, operations of obtaining a plurality of images for the bean through FIGS. 3, 4, and 5 are illustrated as independent operations, but are not limited thereto. For example, the processor 740 may obtain a plurality of images for the bean at different times through the plurality of camera modules, respectively, as illustrated in FIG. 5 while capturing the bean through the plurality of camera modules in the example of FIG. 3.

In operation 803, in an embodiment, the processor 740 may calculate the probabilities that the bean belongs to each of a plurality of classification items based on the plurality of images.

In an embodiment, the processor 740 may perform an operation of processing the plurality of images to determine the type of the bean after obtaining the plurality of images.

In an embodiment, the processor 740 may detect the bean from each of the plurality of images. For example, the processor 740 may detect the bean in each of the plurality of images using a designated algorithm or a designated artificial intelligence model for detecting the bean. For example, the processor 740 may detect the area including the bean in each of the plurality of images. The processor 740 may determine a bounding box including the bean as the area where the bean is detected in each of the plurality of images. The processor 740 may crop the area including the bean (e.g., the area of the bounding box including the bean) in each of the plurality of images. The processor 740 may obtain cropped areas (hereinafter referred to as “cropped areas”) including the bean from the plurality of images.

In an embodiment, the processor 740 may calculate the probabilities that the bean belong to each of the plurality of classification items based on the plurality of cropped areas.

In an embodiment, the plurality of classification items related to the bean may include 12 classification items. For example, the plurality of classification items related to the bean may be as follows.

TABLE 1

| Classification | |
|---|---|
| item of bean (type | |
| of bean) | Description of classification item |
| normal bean | defect-free green bean |
| black bean | A green bean with the inner/outer surfaces fully darkened, which |
| | results from too late harvesting or contact with black fruit |
| over-fermented | A bean overall yellowish or reddish brown, which is one over ripened |
| bean | or fermented on an over-moistened tree, or harvested from cherries that |
| | have fallen to the ground |
| moldy bean | A yellow or reddish brown bean with mold This mainly occurs due to |
| | inappropriate storage temperature and humidity during the distribution |
| | process |
| worm-eaten bean | A bean with one or more holes visible on the outside, mainly caused |
| | by borers |
| dry bean | A bean partially or fully covered in a dry shell |
| chlorotic bean | A bean that has turned pale or white, due to poor drying or storage, or |
| | lack of moisture after treatment |
| deformed bean | A bean with wrinkled surfaces and green or yellowish silverskin, |
| | harvested immature |
| shell bean | A deformed bean shaped as a thin clam shell or ear, caused by genetic |
| | factors |
| broken bean | A bean broken due to incorrect pulping or threshing |
| cracked bean | A bean with cracked ends, caused by incorrect drying |
| foreign substance | A foreign substance not removed during harvesting or screening, such |
| | as a stone or a piece of wood or glass |

However, Table 1 is an example of classifying a bean, and the classification items used by the processor 740 to classify beans may be different from Table 1.

In an embodiment, the processor 740 may calculate the probabilities that the bean belong to each of the plurality of classification items based on the plurality of cropped areas, using an artificial intelligence model.

In an embodiment, the artificial intelligence model may be generated through machine learning. Such learning may be performed, e.g., by the electronic device where the artificial intelligence model is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

In an embodiment, the processor 740 may calculate the probabilities that the bean belong to each of the plurality of classification items from each of the plurality of images. For example, the processor 740 may calculate the probabilities that the bean belongs to each of the plurality of classification items based on the form, shape, and/or color of one surface of the bean in each of the plurality of cropped areas. For example, when the number of the plurality of cropped areas is three, each of the three cropped areas may include one surface of the bean. The processor 740 may calculate the probabilities that the bean belongs to each of the plurality of classification items based on the form, shape, and/or color of one surface of the bean in each of the three cropped areas.

In the above-described example, the probabilities that the bean belongs to each of the plurality of classification items is calculated using an artificial intelligence model, but the disclosure is not limited thereto. For example, the processor 740 may calculate the probabilities that the bean belong to each of the plurality of classification items based on the plurality of cropped areas, using a designated algorithm.

In operation 805, in an embodiment, the processor 740 may classify the bean based on the probabilities that the bean belongs to each of a plurality of classification items.

In an embodiment, the processor 740 may identify the classification item (type) of the bean having the highest probability for each of the plurality of images (e.g., the plurality of cropped areas) based on the probabilities that the bean belongs to each of the plurality of classification items. For example, when the plurality of images include a first image and a second image, the processor 740 may determine to identify that the probability that the first bean belongs to the normal bean is the highest based on the first image and identify that the probability that the first bean belongs to the shell bean is the highest based on the second image.

In an embodiment, when the classification items of the bean having the highest probability in the plurality of images are the same, the processor 740 may determine that the same classification item is the type of the bean. For example, when the plurality of images include a first image and a second image, the processor 740 may determine that the type of the bean is the normal bean when the probability that the first bean belongs to the normal bean in the first image is the highest, and the probability that the first bean belongs to the normal bean in the second image is the highest.

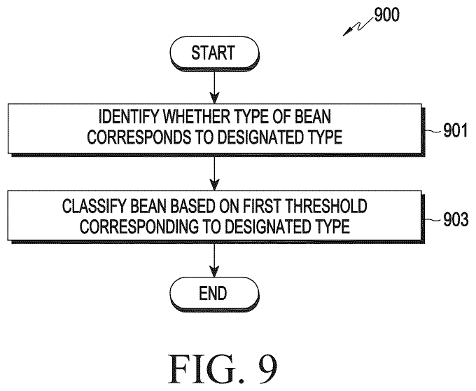

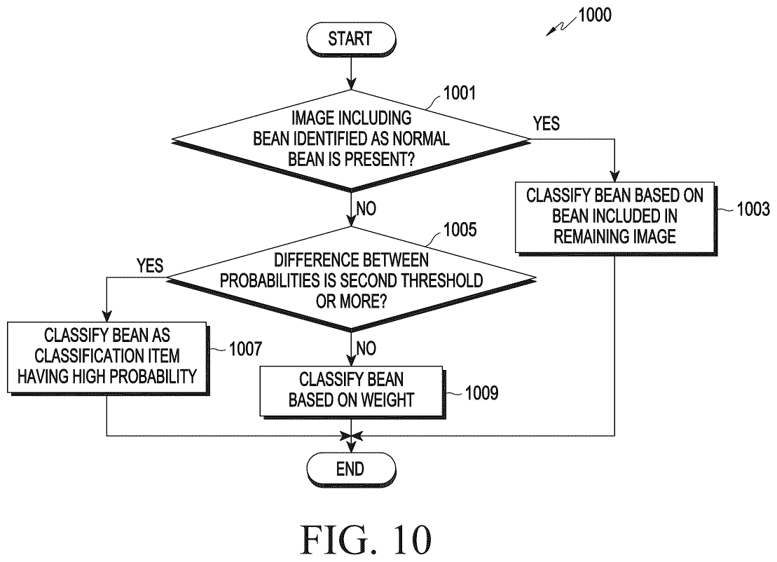

In an embodiment, when the classification items of the bean having the highest probability in the plurality of images are different (e.g., when there are bean classification items having the highest probability), the processor 740 may determine the type of the bean based on whether the type of the bean having the highest probability corresponds to a designated type, whether there is an image where it is identified as a normal bean, a difference between the highest probabilities, and/or a weight assigned to the type of bean. This is described in more detail with reference to FIGS. 9 and 10.

FIG. 9 is a flowchart 900 illustrating a method for classifying a bean according to an embodiment.

Referring to FIG. 9, in operation 901, in an embodiment, the processor 740 may identify whether the type of bean having the highest probability corresponds to a designated type.

In an embodiment, as described above, the processor 740 may identify the classification item (type) of the bean having the highest probability for each of the plurality of images (e.g., the plurality of cropped areas) based on the probabilities that the bean belongs to each of the plurality of classification items.

In an embodiment, the processor 740 may identify whether the classification items of the bean having the highest probability belong to the classification items designated by the user. For example, the processor 740 may designate black bean, over-fermented bean, moldy bean, worm-eaten bean, and foreign substance as designated classification items among the classification items in Table 1. In an embodiment, when coffee is made using black beans, over-fermented beans, moldy beans, and worm-eaten beans, they may be classification items that are likely to make tasteless coffee. The foreign substance may be a classification item that may cause a failure of the device for making coffee.

In operation 903, in an embodiment, the processor 740 may classify the bean based on a first threshold corresponding to a designated type.

In an embodiment, when the type of bean having the highest probability corresponds to the designated type, the processor 740 may compare the highest probability of the bean and the first threshold corresponding to the designated type (hereinafter referred to as a “first threshold” or “first threshold probability”). For example, the processor 740 may compare the probability with the first threshold when the probability that the bean belongs to foreign substance in the first image is the highest. For example, when the probability that the bean belongs to the foreign substance in the first image is the highest and the probability that the bean belongs to the deformed bean in the second image is the highest, the processor 740 may compare the probability that the bean belongs to the foreign substance with the first threshold.

In an embodiment, the first threshold may be set only for the designated types. For example, the first threshold may be set only for each of black bean, over-fermented bean, moldy bean, worm-eaten bean, and foreign substance. For example, at least some of the first thresholds set for the black bean, over-fermented bean, moldy bean, worm-eaten bean, and foreign substance, respectively, may be set to different values.

In an embodiment, when the highest probability of the bean corresponding to the designated type in at least one image is larger than or equal to the first threshold, the processor 740 may determine the designated type of the bean as the type of bean corresponding to the first threshold. For example, the processor 740 may determine the type of bean as the foreign substance when the probability that the bean belongs to the foreign substance in the first image is 40% (e.g., when 40% which is the probability that the bean belongs to the foreign substance in the first image is larger than each of the probabilities that the bean belongs to the other classification items), and the first threshold is 37%. For example, the probability that the bean belongs to the foreign substance in the first image may be 40% (e.g., when 40% which is the probability that the bean belongs to the foreign substance in the first image is larger than each of the probabilities that each belongs to the other classification items), and the first threshold may be 37%. In the second image, the probability that the bean belong to the deformed bean may be 50% (e.g., when the probability that the bean belong to the deformed bean in the second image is larger than the probabilities that the bean belong to other classification items, respectively). As such, even when 50% which is the probability that the bean belongs to the deformed bean from the second image is larger than 40% which is the probability that the bean belongs to the foreign substance from the first image, the processor 740 may determine that the type of the bean is a foreign substance, not a deformed bean, based on identifying that 40% which is the probability that the bean belongs to the foreign substance is larger than or equal to the first threshold 37% corresponding to the foreign substance.

In an embodiment, when the type of the bean having the highest probability does not correspond to the designated type or, although the type of the bean having the highest probability corresponds to the designated type, the highest probability of the bean is less than the first threshold, the processor 740 may determine the type of the bean based on whether there is an image where it is identified as a normal bean, a difference between the highest probabilities, and/or a weight assigned to the type of bean. This is described in more detail with reference to FIG. 10.

FIG. 10 is a flowchart 1000 illustrating a method for classifying a bean according to an embodiment.

Referring to FIG. 10, in operation 1001, in an embodiment, the processor 740 may identify whether there is an image including a bean identified as a normal bean.

As described above, in an embodiment, when the type of the bean having the highest probability does not correspond to the designated type or, although the type of the bean having the highest probability corresponds to the designated type, the highest probability of the bean corresponding to the designated type is less than the first threshold, the processor 740 may identify whether there is an image identified as a normal bean.

In an embodiment, the processor 740 may identify whether there is an image having the highest probability that bean belongs to the normal bean among the plurality of images.

When it is identified that there is an image including a bean identified as a normal bean is present in operation 1001, in operation 1003, in an embodiment, the processor 740 may classify the bean based on the types of the bean included in the remaining images. For example, when the plurality of images include a first image and a second image, the processor 740 may identify that the type to which the bean belongs with the highest probability in the first image is normal bean, and the type to which the bean belongs with the highest probability in the second image is deformed bean. The processor 740 may determine the deformed bean having the highest probability in the second image as the remaining image as the type of the bean.

When it is identified that there is no image including a bean identified as a normal bean in operation 1001, in operation 1005, in an embodiment, the processor 740 may identify whether a difference between the highest probabilities calculated in the plurality of images is larger than or equal to a second threshold.

In an embodiment, the processor 740 may identify the difference between the highest probabilities calculated in the plurality of images. For example, when the plurality of images include a first image and a second image, the processor 740 may identify that the probability that the bean belongs to the deformed bean in the first image is 70% as the highest probability, and the probability that the bean belongs to the broken bean in the second image is 87% as the highest probability. The processor 740 may identify that the difference between 70% and 87% is 17%.

In an embodiment, the difference between the highest probabilities calculated in the plurality of images and the second threshold (hereinafter, referred to as a “second threshold”) may be compared.

When the difference between the highest probabilities calculated in the plurality of images in operation 1005 is larger than or equal to the second threshold, in operation 1007, in an embodiment, the processor 740 may classify the bean with classification items having a higher probability (e.g., the highest probability) than the other probabilities among the highest probabilities calculated in the plurality of images.

In an embodiment, when the plurality of images include a first image and a second image, the processor 740 may identify that the probability that the bean belongs to the deformed bean in the first image is 70% as the highest probability, and the probability that the bean belongs to the broken bean in the second image is 87% as the highest probability. The processor 740 may identify that the difference between 70% and 87% is 17%. The processor 740 may identify that the difference of 17% is larger than or equal to the second threshold of 15%. The processor 740 may determine the broken bean having the higher probability, 87%, of 70% and 87%, as the type of the bean.

When the difference between the highest probabilities calculated in the plurality of images in operation 1005 is less than the second threshold, in operation 1009, in an embodiment, the processor 740 may classify the bean based on weights assigned to the bean classification items, respectively.

In an embodiment, the processor 740 may set a weight (hereinafter, referred to as a “weight”) (or priority) for each bean classification item.

In an embodiment, the processor 740 may classify the bean based on the highest probabilities calculated in the plurality of images and the weights. For example, the processor 740 may identify that the probability that the bean belongs to the deformed bean in the first image is 80% as the highest probability, and the probability that the bean belongs to the broken bean in the second image is 87% as the highest probability. When the weight assigned to the deformed bean is 0.6, and the weight assigned to the broken bean is 0.4, if the product of the probability 80% and the weight 0.6 for the deformed bean is larger than the product of the probability 87% and the weight 0.4 for the broken bean, the processor 740 may determine the type of the bean as the deformed bean.

In the above-described examples, the processor 740 performs the operations for classifying the bean in the order of the operation of classifying the bean based on whether the type of the bean having the highest probability corresponds to a designated type, the operation of classifying the bean based on whether there is an image where it is identified as a normal bean, the operation of classifying the bean based on the difference between the highest probabilities, and the operation of classifying the bean based on the weight assigned to the type of the bean, but is not limited thereto. For example, the processor 740 may perform the above-described operations for classifying the bean in a different order from the above-described order. For example, the processor 740 may classify the bean by performing the remaining operations without performing some of the above-described operations for classifying the bean.

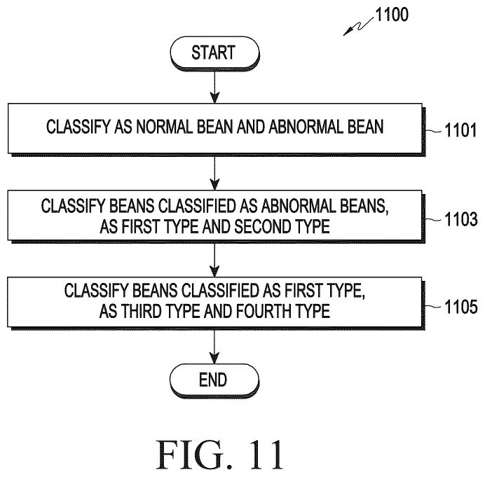

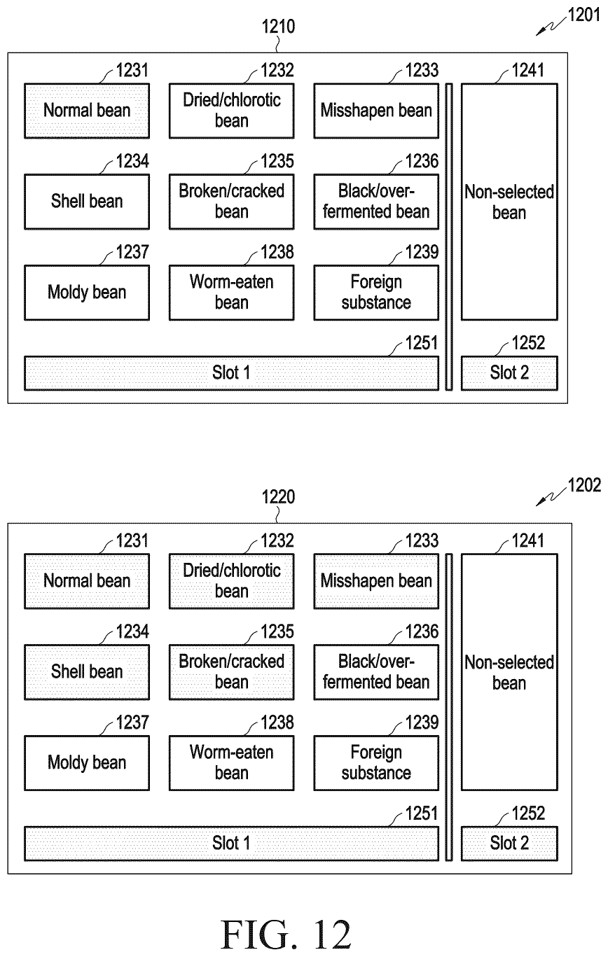

FIG. 11 is a flowchart 1100 illustrating a method for classifying beans by a first method according to an embodiment.

FIG. 12 is a view illustrating an example of a method for classifying beans by a first method according to an embodiment.

Referring to FIGS. 11 and 12, in an embodiment, the electronic device 100 may classify the bean using a method using a plurality of classification steps (hereinafter referred to as “first method” or “cascade method”).

In operation 1101, in an embodiment, the electronic device 100 may classify beans as normal beans and abnormal beans in the first step. For example, the electronic device 100 may classify beans as normal beans and abnormal beans (e.g., beans corresponding to types other than normal beans) through the operations described through FIGS. 8 to 10. In an embodiment, the electronic device 100 may collect beans classified as normal beans through the area of the rotating plate 140 corresponding to the normal bean (e.g., by opening the area of the rotating plate 140 corresponding to the normal bean). In an embodiment, the electronic device 100 may collect bean classified as abnormal beans through the area of the rotating plate 140 corresponding to the abnormal bean (e.g., by opening the area of the rotating plate 140 corresponding to the abnormal bean).

In operation 1103, in an embodiment, the electronic device 100 may classify the beans classified as abnormal beans as a first type and a second type in the second step. For example, the electronic device 100 may classify the beans corresponding to the first type (e.g., black beans, over-fermented beans, moldy beans, worm-eaten beans, and foreign substances) and beans corresponding to the second type (e.g., normal beans and beans not corresponding to the first type).

In an embodiment, the electronic device 100 may collect beans classified as the first type through the area of the rotating plate 140 corresponding to the first type (e.g., by opening the area of the rotating plate 140 corresponding to the first type). In an embodiment, the electronic device 100 may collect beans classified as the second type through the area of the rotating plate 140 corresponding to the second type (e.g., by opening the area of the rotating plate 140 corresponding to the second type).

In operation 1105, in an embodiment, the electronic device 100 may classify the beans classified as the second type as a third type and a fourth type in the third step. For example, the electronic device 100 may classify the beans corresponding to the third type (e.g., broken beans, cracked heads, and deformed beans corresponding to the types available as coffee beans) and beans corresponding to the fourth type (e.g., beans that do not correspond to the normal bean, the first type, and the third type).

In the above-described example, three steps are illustrated, such as the first step, the second step, and the third step, but the disclosure is not limited thereto. For example, the electronic device 100 may classify the beans using two steps or four or more steps.

In the above example, beans are classified as normal and abnormal beans through the first step, beans classified as abnormal beans through the second step are classified as the first type and the second type, and beans classified as the second type through the third step are classified as the third type and the third type, but the disclosure is not limited thereto. For example, the electronic device 100 may select the type of the bean to be classified in each of the first, second, and third steps based on a user input.

In an embodiment, the electronic device 100 may classify beans using a plurality of steps (e.g., the first step, the second step, and the third step), thereby addressing size and storage container limitations due to the structural limit of the electronic device 100.

In an embodiment, the electronic device 100 may classify only the type of the beans desired by the user by selectively performing a plurality of steps (e.g., the first, second, and third steps) of classifying beans based on a user input.

In an embodiment, as illustrated by reference number 1201, the processor 740 may display a screen 1210 including a plurality of objects 1231, 1232, 1233, 1234, 1235, 1236, 1237, 1238, and 1239 corresponding to a plurality of types of bean through the display module 720. The processor 740 may perform the operation of classifying beans as normal beans and abnormal beans based on a user input of selecting the object 1231 corresponding to the normal bean. On the screen 1210, slot 1 1251 may be an object corresponding to a discharge port through which beans to be classified as normal beans corresponding to the object 1231 selected by the user input are discharged. On the screen 1210, the object 1241 may be an object (e.g., an object representing classification items corresponding to a plurality of objects 1232, 1233, 1234, 1235, 1236, 1237, 1238, and 1239) representing the type of bean other than the type of bean selected by the user input. On the screen 1210, slot 2 1251 may be an object corresponding to a discharge port through which beans of types of classification items not selected by the user input are discharged.

In an embodiment, as illustrated by reference number 1202, the processor 740 may display a screen 1220 including a plurality of objects 1231, 1232, 1233, 1234, 1235, 1236, 1237, 1238, and 1239 corresponding to a plurality of types of bean through the display module 720. The processor 740 may perform the operation of classifying beans as the types corresponding to the selected objects and the remaining types based on a user input for selecting the object 1231 corresponding to normal beans, the object 1232 corresponding to dry/chlorotic beans, the object 1233 corresponding to deformed beans, the object 1234 corresponding to shell beans, and/or the object 1235 corresponding to broken/cracked beans.

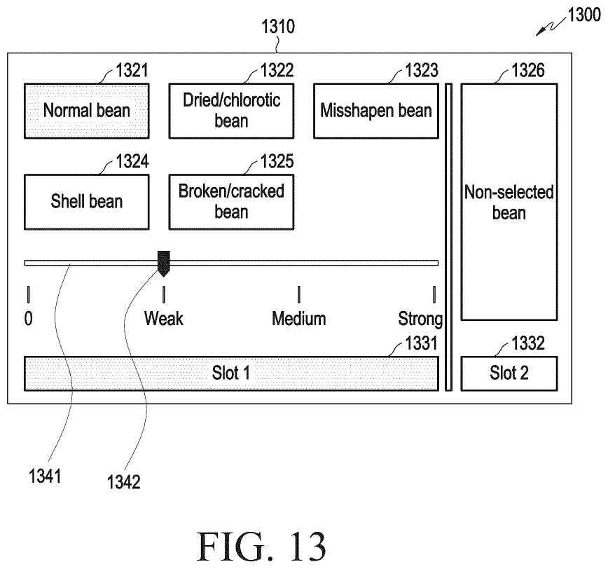

FIG. 13 is a view 1300 illustrating an example of a method for classifying beans by a second method according to an embodiment.

Referring to FIG. 13, in an embodiment, the electronic device 100 may classify the bean using a method of setting a first threshold, a second threshold, and/or a weight by a user input (hereinafter referred to as a “second method” or a “user mode”).

In an embodiment, the processor 740 may display a screen for setting the first threshold through the display module 720. For example, the processor 740 may display a screen 1310 including a plurality of objects 1321, 1322, 1323, 1324, and 1325 corresponding to a plurality of classification items, an object 1342 for setting a first threshold, a bar 1341 where the object 1342 is moved, slot 1 1331, slot 2 1332, and/or an object 1326, through the display module 720.

In an embodiment, the processor 740 may set the strength of the first threshold corresponding to the classification item (e.g., normal bean) of the selected object (e.g., the object 1321) based on a user input (e.g., a drag input) for moving the object 1342. For example, when the strength of the first threshold is set to “weak”, the processor 740 may set the first threshold to 60%. When the strength of the first threshold is set to “weak”, the processor 740 may determine the type of the bean as the designated classification item when there is at least one image where the probability of the designated classification item having the highest probability is 60% or more among the plurality of images. For example, when the strength of the first threshold is set to “medium”, the processor 740 may set the first threshold to 80%. When the strength of the first threshold is set to “medium”, the processor 740 may determine the type of the bean as the designated classification item when there is at least one image where the probability of the designated classification item having the highest probability is 80% or more among the plurality of images. For example, when the strength of the first threshold is set to “strong”, the processor 740 may set the first threshold to 80%. When the strength of the first threshold is set to “strong”, the processor 740 may determine the type of the bean as the designated classification item only when the classification item having the highest probability in all of the plurality of images corresponds to the designated classification item, and the probabilities of the designated classification item in all of the plurality of images are 80% or more. For example, when the strength of the first threshold is set to “0”, the processor 740 may exclude the classification item of the selected object from the items for classifying the bean.

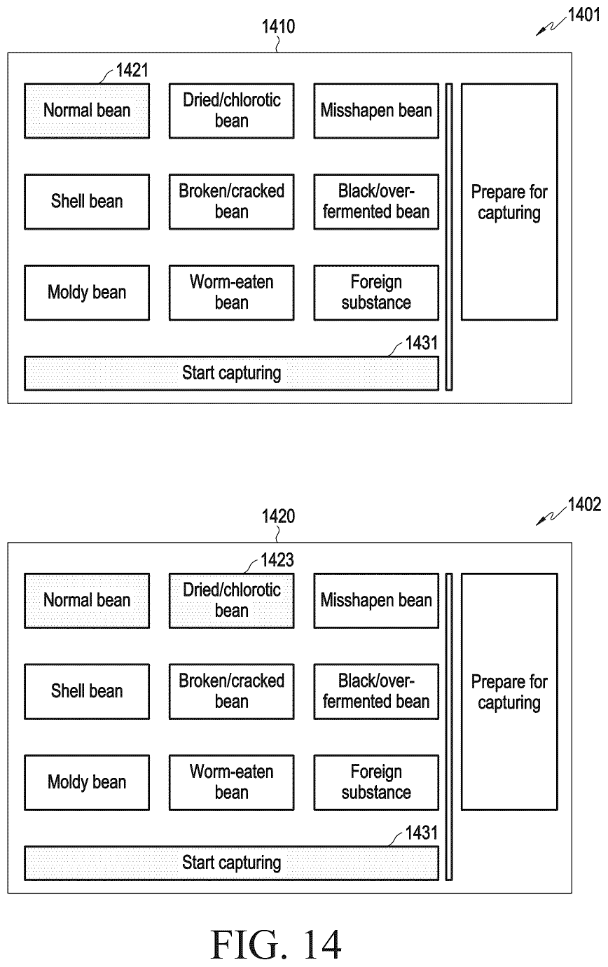

FIG. 14 is a view illustrating an example of a method for classifying beans by a third method according to an embodiment.

Referring to FIG. 14, in an embodiment, the electronic device 100 may classify the bean using a method of setting a first threshold, a second threshold, and/or a weight based on training data learned for each user (e.g., a person making coffee using classified beans) (hereinafter, referred to as a “third method” or an “adaptive mode”). For example, after a user inputting (e.g., inserting) a bean classified by the user (e.g., a bean which the user manually classify) into the electronic device 100, the electronic device 100 may determine, an artificial intelligence model, a type of the bean. The electronic device 100 may set (automatically set) the first threshold, the second threshold, and/or the weight.

In an embodiment, the processor 740 may sequentially input (e.g., insert) beans classified by type by the user to the electronic device 100 (e.g., the first space 141) and then obtain images for the bean. For example, at reference numeral 1401, when a user input for selecting the object 1421 corresponding to normal bean on the screen 1410 is received, and beans classified as normal beans are input to the electronic device 100 by the user, the processor 740 may obtain a plurality of images for the input beans. After the plurality of images are obtained, at reference numeral 1402, when a user input for selecting the object 1423 corresponding to dry bean/chlorotic bean on the screen 1420 is received, and beans classified as dry beans/chlorotic beans are input to the electronic device 100 by the user, the processor 740 may obtain a plurality of images for the input beans. Like at reference number 1401 and reference number 1402, when user inputs for selecting the objects corresponding to the remaining types are sequentially received, and beans classified as the corresponding type are input to the electronic device 100 by the user, the processor 740 may obtain a plurality of images for the corresponding type of beans.

In an embodiment, the processor 740 may set, using the plurality of images for the corresponding type of beans, thresholds (e.g., the first threshold of FIG. 9 and/or the second threshold of FIG. 10) (and the weighs of FIG. 10). For example, after an object corresponding to a worm-eaten bean by a user is selected in a state in which the first threshold for the worm-eaten bean is set as a threshold 1 (e.g., about 80%), the user may insert beans classified by the user into the electronic device 100. The processor 740 may identify, based on images for the beans obtained through the plurality of cameras, that an average of probabilities that each of the beans belongs to the worm-eaten bean is probability 1 (e.g., about 90%). In this case, the processor 740 may adjust (e.g., automatically adjust) the first threshold for the worm-eaten bean from the threshold 1 to probability 1.

In an embodiment, while a bean, classified as a first type by a user, is moved on the transparent plate, the processor 740 may simultaneously obtain a first image for an upper surface of the bean through the first camera and a second image for a lower surface of the bean through the second camera. The processor 740 may, using an artificial intelligence (AI) model, calculate, based on the first image, first probabilities that the bean belongs to each of a plurality of classification items and calculate, based on the second image, second probabilities that the bean belongs to each of the plurality of classification items. The processor 740 may identify, among the plurality of classification items, a first classification item corresponding to a third probability highest among the first probabilities and identify, among the plurality of classification items, a second classification item corresponding to a fourth probability highest among the second probabilities. The processor 740 may set a probability of a classification item corresponding to the first type between the first classification item and the second classification item between the third probability and the fourth probability, as the first threshold for the first type of the bean. The processor 740 may set a difference between the third probability and the fourth probability as the second threshold for the first classification item and the second classification item.

In an embodiment, after the first threshold, the second threshold, and/or the weight are set, the processor 740 may perform, based on the set the first threshold, the second threshold, and/or the weight, an operation of classifying the bean using the artificial intelligence (AI) model.

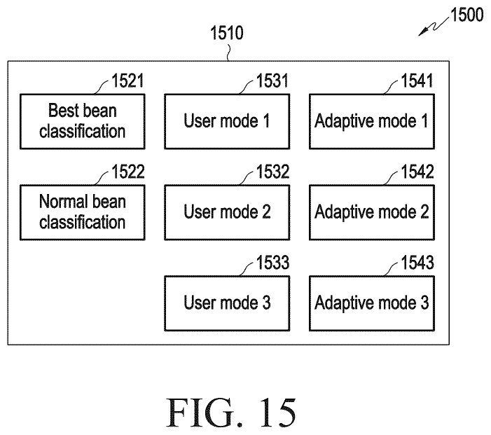

FIG. 15 is a view 1500 illustrating an example of a method for selecting a method for classifying beans based on a user input according to an embodiment.

Referring to FIG. 15, in an embodiment, the processor 740 may select the above-described first method, second method, and third method based on a user input. For example, the processor 740 may display a screen 1510 including objects 1521 and 1522 corresponding to the first method, objects 1531, 1532, and 1533 corresponding to the second method, and/or objects 1541, 1542, and 1543 corresponding to the third method through the display module 720.

In an embodiment, the processor 740 may perform an operation of classifying normal beans of the highest quality and other types of beans based on a user input of selecting the object 1521. When the object 1522 is selected after the operation of classifying the bean is performed by the selection of the object 1521, the processor 740 may perform an operation of classifying normal beans or beans of a type available for making coffee.

In an embodiment, the processor 740 may perform an operation of classifying beans using a setting set by user mode 1 (e.g., user 1) based on a user input of selecting the object 1531.

In an embodiment, the processor 740 may perform an operation of classifying beans using an artificial intelligence model trained using training data corresponding to adaptive mode 2 (e.g., user 2) based on a user input of selecting the object 1541.

Although the operation of classifying beans has been described with reference to FIGS. 1 to 15, classifiable grains are not limited to beans. For example, the embodiments of the disclosure may be applied equally or similarly to other grains as well as beans.

In an embodiment, a method for classifying a bean by an electronic device may comprise while a bean is moved on a transparent plate of the electronic device, simultaneously obtain a first image for a first surface of the bean through a first camera and a second image for a second surface of the bean through a second camera, the second surface being different from the first surface, wherein the first camera and the second camera are included in a plurality of cameras, the first camera being disposed to face one surface of the transparent plate, the second camera being disposed to face a surface, opposite to the one surface, of transparent plate; using an artificial intelligence (AI) model, calculating, based on the first image, first probabilities that the bean belongs to each of a plurality of classification items and calculating, based on the second image, second probabilities that the bean belongs to each of the plurality of classification items; identifying, among the plurality of classification items, a first classification item corresponding to a third probability highest among the first probabilities and identifying, among the plurality of classification items, a second classification item corresponding to a fourth probability highest among the second probabilities; based on the first classification item being a same as the second classification item, determining the first classification item as a type of the bean; based on the first classification item being not a same as the second classification item, identifying whether the first classification item or the second classification item corresponds to a designated classification item, wherein the designated classification item is designated by a user input; based on the first classification item or the second classification item corresponding to the designated classification item, identifying whether a probability of a classification item, corresponding to the designated classification item between the first classification item and the second classification item, between the third probability and the fourth probability is greater than or equal to a first threshold; and based on the probability of the classification item corresponding to the designated classification item being greater than or equal to the first threshold, determining the classification item as the type of the bean.

In an embodiment, the method may further comprise based on the first classification item and the second classification item not corresponding to the designated classification item or the probability of the classification item corresponding to the designated classification item being less than the first threshold, identifying whether the first classification item or the second classification item corresponds to a normal bean among the plurality of classification items; and based on the first classification item or the second classification item corresponding to the normal bean, determining, as the type of the bean, a classification item which does not correspond to normal bean between the first classification item and the second classification item.

In an embodiment, the method may further comprise based on the first classification item and the second classification item not corresponding to the normal bean among the plurality of classification items, identifying whether a difference between the third probability and the fourth probability is greater than or equal to a second threshold; and based on the difference between the third probability and the fourth probability being greater than or equal to the second threshold, determining, as the type of the bean, a classification item, corresponding to probability higher between the third probability and the fourth probability, between the first classification item and the second classification item.

In an embodiment, the method may further comprise based on the difference between the third probability and the fourth probability being less than the second threshold, identifying weights set for the first classification item and the second classification item; and based on the third probability, the fourth probability, and the weights, determining the type of the bean.

In an embodiment, the method may further comprise based on a user input, setting the weights.

In an embodiment, the method may further comprise based on a user input, setting the first threshold corresponding to the classification.

In an embodiment, the first surface of the bean may include an upper surface of the bean, and the second surface of the bean may include a lower surface of the bean.

In an embodiment, the first image and the second image may include still images or moving images.

Further, the structure of the data used in embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a CD-ROM or a DVD).

What is claimed is:

1. An electronic device, comprising:
a transparent plate;
a plurality of cameras including a first camera and a second camera, the first camera being disposed to face one surface of the transparent plate, the second camera being disposed to face a surface, opposite to the one surface, of transparent plate; and
at least one processor, wherein the at least one processor is configured to:
while a bean is moved on the transparent plate, simultaneously obtain a first image for a first surface of the bean through the first camera and a second image for a second surface of the bean through the second camera, the second surface being different from the first surface;
using an artificial intelligence (AI) model, calculate, based on the first image, first probabilities that the bean belongs to each of a plurality of classification items and calculate, based on the second image, second probabilities that the bean belongs to each of the plurality of classification items;
identify, among the plurality of classification items, a first classification item corresponding to a third probability highest among the first probabilities and identify, among the plurality of classification items, a second classification item corresponding to a fourth probability highest among the second probabilities;
based on the first classification item being a same as the second classification item, determine the first classification item as a type of the bean;
based on the first classification item being not a same as the second classification item, identify whether the first classification item or the second classification item corresponds to a designated classification item, wherein the designated classification item is designated by a user input;
based on the first classification item or the second classification item corresponding to the designated classification item, identify whether a probability of a classification item, corresponding to the designated classification item between the first classification item and the second classification item, between the third probability and the fourth probability is greater than or equal to a first threshold; and
based on the probability of the classification item corresponding to the designated classification item being greater than or equal to the first threshold, determine the classification item as the type of the bean.

2. The electronic device of claim 1, further comprising at least one patch,
wherein the at least one processor is further configured to:
obtain an image for the at least one patch through the plurality of cameras; and
based on the image for the at least one patch, set a setting related to auto white balance and/or auto color correction of the plurality of cameras.

3. The electronic device of claim 1, wherein the at least one processor is further configured to:
based on the first classification item and the second classification item not corresponding to the designated classification item or the probability of the classification item corresponding to the designated classification item being less than the first threshold, identify whether the first classification item or the second classification item corresponds to a normal bean among the plurality of classification items; and
based on the first classification item or the second classification item corresponding to the normal bean, determine, as the type of the bean, a classification item which does not correspond to normal bean between the first classification item and the second classification item.

4. The electronic device of claim 3, wherein the at least one processor is further configured to:
based on the first classification item and the second classification item not corresponding to the normal bean among the plurality of classification items, identify whether a difference between the third probability and the fourth probability is greater than or equal to a second threshold; and
based on the difference between the third probability and the fourth probability being greater than or equal to the second threshold, determine, as the type of the bean, a classification item, corresponding to probability higher between the third probability and the fourth probability, between the first classification item and the second classification item.

5. The electronic device of claim 4, wherein the at least one processor is further configured to:
based on the difference between the third probability and the fourth probability being less than the second threshold, identify weights set for the first classification item and the second classification item, and
based on the third probability, the fourth probability, and the weights, determine the type of the bean.

6. The electronic device of claim 5, wherein the at least one processor is further configured to:
based on a user input, set the weights.

7. The electronic device of claim 1, wherein the at least one processor is further configured to:
based on a user input, set the first threshold corresponding to the classification item.

8. The electronic device of claim 1, wherein the first surface of the bean includes an upper surface of the bean, and the second surface of the bean includes a lower surface of the bean.

9. The electronic device of claim 1, wherein the first image and the second image includes still images or moving images.

10. A method for classifying a bean by an electronic device, the method comprising:
while a bean is moved on a transparent plate of the electronic device, simultaneously obtain a first image for a first surface of the bean through a first camera and a second image for a second surface of the bean through a second camera, the second surface being different from the first surface, wherein the first camera and the second camera are included in a plurality of cameras, the first camera being disposed to face one surface of the transparent plate, the second camera being disposed to face a surface, opposite to the one surface, of transparent plate;
using an artificial intelligence (AI) model, calculating, based on the first image, first probabilities that the bean belongs to each of a plurality of classification items and calculating, based on the second image, second probabilities that the bean belongs to each of the plurality of classification items;
identifying, among the plurality of classification items, a first classification item corresponding to a third probability highest among the first probabilities and identifying, among the plurality of classification items, a second classification item corresponding to a fourth probability highest among the second probabilities;
based on the first classification item being a same as the second classification item, determining the first classification item as a type of the bean;
based on the first classification item being not a same as the second classification item, identifying whether the first classification item or the second classification item corresponds to a designated classification item, wherein the designated classification item is designated by a user input;
based on the first classification item or the second classification item corresponding to the designated classification item, identifying whether a probability of a classification item, corresponding to the designated classification item between the first classification item and the second classification item, between the third probability and the fourth probability is greater than or equal to a first threshold; and
based on the probability of the classification item corresponding to the designated classification item being greater than or equal to the first threshold, determining the classification item as the type of the bean.

11. The method of claim 10, further comprising:
obtaining an image for the at least one patch through the plurality of cameras; and
based on the image for the at least one patch, setting a setting related to auto white balance and/or auto color correction of the plurality of cameras.

12. The method of claim 10, further comprising:
based on the first classification item and the second classification item not corresponding to the designated classification item or the probability of the classification item corresponding to the designated classification item being less than the first threshold, identifying whether the first classification item or the second classification item corresponds to a normal bean among the plurality of classification items; and
based on the first classification item or the second classification item corresponding to the normal bean, determining, as the type of the bean, a classification item which does not correspond to normal bean between the first classification item and the second classification item.

13. The method of claim 12, further comprising:
based on the first classification item and the second classification item not corresponding to the normal bean among the plurality of classification items, identifying whether a difference between the third probability and the fourth probability is greater than or equal to a second threshold; and
based on the difference between the third probability and the fourth probability being greater than or equal to the second threshold, determining, as the type of the bean, a classification item, corresponding to probability higher between the third probability and the fourth probability, between the first classification item and the second classification item.

14. The method of claim 13, further comprising:
based on the difference between the third probability and the fourth probability being less than the second threshold, identifying weights set for the first classification item and the second classification item; and
based on the third probability, the fourth probability, and the weights, determining the type of the bean.

15. The method of claim 14, further comprising:
based on a user input, setting the weights.

16. The method of claim 10, further comprising:
based on a user input, setting the first threshold corresponding to the classification item.

17. The method of claim 10, wherein the first surface of the bean includes an upper surface of the bean, and the second surface of the bean includes a lower surface of the bean.

18. The method of claim 10, wherein the first image and the second image includes still images or moving images.

19. An electronic device, comprising:
a transparent plate;
a plurality of cameras including a first camera and a second camera, the first camera being disposed to face one surface of the transparent plate, the second camera being disposed to face a surface, opposite to the one surface, of transparent plate; and
at least one processor, wherein the at least one processor is configured to:
while a bean, classified as a first type by a user, is moved on the transparent plate, simultaneously obtain a first image for an upper surface of the bean through the first camera and a second image for a lower surface of the bean through the second camera;
using an artificial intelligence (AI) model, calculate, based on the first image, first probabilities that the bean belongs to each of a plurality of classification items and calculate, based on the second image, second probabilities that the bean belongs to each of the plurality of classification items;
identify, among the plurality of classification items, a first classification item corresponding to a third probability highest among the first probabilities and identify, among the plurality of classification items, a second classification item corresponding to a fourth probability highest among the second probabilities; and
based on a probability of a classification item corresponding to the first type between the first classification item and the second classification item between the third probability and the fourth probability, set a threshold for classifying the bean.

20. The electronic device of claim 19, wherein the at least one processor is further configured to:
based on the probability of the classification item being different from a previously set threshold, set the probability of the classification item as the threshold for classifying the bean.
